(19) United States
(12) Patent Application Publication
(10) Pub. No.: US 2026/0329915 A1
(43) Pub. Date: Oct. 22, 2026

(54) COMMUNITY-BASED HIERARCHICAL DOCUMENT RETRIEVAL SYSTEM USING CONFIDENCE DIVERGENCE BETWEEN UNIVERSAL AND SPECIALIZED LANGUAGE MODELS

(71) Applicants: Vipin Kataria, Fremont, CA (US); Nitin Kumar, Lewisville, TX (US)

(72) Inventors: Vipin Kataria, Fremont, CA (US); Nitin Kumar, Lewisville, TX (US)

(21) Appl. No.: 19/445,454

(22) Filed: Jan. 9, 2026

(51) Int. Cl. G06F 16/335; G06F 16/35

(52) U.S. Cl. CPC G06F 16/335; G06F 16/35

(57) ABSTRACT

A community-based hierarchical document retrieval system uses confidence divergence between universal and specialized language models to identify domain-relevant documents. A universal language model trained on combined data from all document communities provides baseline confidence scores. Specialized language models, each initialized from the universal model and fine-tuned on community-specific data, provide community-specific confidence scores. Confidence divergence, calculated as the difference between specialized and universal confidence scores, indicates domain-specific expertise. Communities with positive divergence are selected for document-level retrieval using document-grounded confidence assessment. Hierarchical model initialization ensures comparable confidence calibration across all models, enabling confidence divergence to serve as a reliable routing signal. The system automatically identifies relevant domains without requiring manual domain classification or explicit routing rules. Experimental validation demonstrates 18% improvement in precision and 35% improvement in recall over standard retrieval augmented generation systems in specialized domains including legal, medical, and technical document retrieval.

### TECHNICAL FIELD

The present disclosure generally relates to the field of artificial intelligence (AI) and natural language processing (NLP), and more particularly to information retrieval and document ranking in knowledge-intensive applications.

### BACKGROUND

In AI-driven information retrieval technologies, the ability to provide accurate, relevant, and contextually appropriate responses to user queries is of increasing importance. Traditional systems, particularly those employing large language models (LLMs), have made significant strides in automating customer service, healthcare, educational applications, environmental, and legal information retrieval. However, these systems are not without their limitations.

A notable challenge faced by current implementations is the phenomenon known as “hallucination,” where systems generate responses that are factually incorrect, speculative, or entirely fabricated. This issue not only undermines the reliability and trustworthiness of such systems but may also impede their effective and responsible usage, especially in domains where accuracy is of particular importance, such as legal and healthcare information retrieval.

One approach used to mitigate the issue of hallucinations, known as retrieval augmented generation or RAG, employs dynamic retrieval of query related information to provide context for an LLM, grounding the LLM's response in relevant knowledge. However, several limitations of RAG exist. In one example, the reliance of conventional RAG systems on semantic similarity to determine which documents are relevant to a user query may result in superficially relevant information being provided to an LLM, which is in fact not related to the user query.

A second, related issue with conventional RAG systems occurs when relevant information is not included in the context provided by an RAG system to an LLM, because the contextually relevant information is superficially dissimilar to the user query.

Another significant challenge in document retrieval is the diversity of knowledge domains within a document collection. A single universal model may lack the specialized expertise required to accurately assess relevance for queries spanning technical, legal, medical, financial, and other specialized domains.

Existing approaches that employ multiple specialized language models typically require explicit domain classification or user-specified routing, which introduces additional points of failure and limits scalability. Furthermore, when multiple specialized language models are trained independently without a shared baseline, their confidence scores may not be directly comparable due to differences in training procedures, regularization strategies, or data distributions. This makes it difficult to automatically determine which specialized language model is most appropriate for a given query.

In light of the limitations of existing RAG approaches and domain-specific retrieval systems, there is a need for a more robust framework for providing context to LLMs as part of satisfying a user query.

### SUMMARY

The current disclosure at least partially addresses the existing limitations of RAG and domain-specific retrieval systems. In one embodiment, a method is provided for information retrieval in response to a user query. The method includes receiving a user query and generating a query embedding for the user query using a trained embedding model.

The method further involves submitting the query to a universal language model to obtain a baseline confidence score and submitting the query to a plurality of specialized language models, each specialized language model being associated with a document community, to obtain community-specific confidence scores.

The method includes calculating a confidence divergence for each community as the difference between the community-specific confidence score and the baseline confidence score.

Communities are ranked based on the confidence divergence, and top-ranked communities are selected for document-level retrieval.

For documents within selected communities, the method includes computing document-grounded confidence scores by providing document content as context to the specialized language model. Documents are ranked based on a multi-factor scoring function incorporating community scores and document-grounded confidence.

In another embodiment, a system is disclosed that includes receiving a user query and generating a query embedding using a trained embedding model, wherein the method accesses a vector database storing document embeddings.

The system further comprises a universal language model trained on data from all communities, and a plurality of specialized language models, each initialized from the universal language model and fine-tuned on community-specific data.

The disclosed methods involve receiving a user query, generating a query embedding, computing confidence divergence across communities, ranking communities by divergence, performing document-level ranking within selected communities, and formulating a ranked document list.

The disclosed embodiments offer an improvement over conventional RAG approaches by utilizing automatic community detection and confidence divergence-based routing to provide more contextually coherent and domain-appropriate document retrieval.

### BRIEF DESCRIPTION OF THE DRAWINGS

Various aspects of the present disclosure may be better understood upon reading the following detailed description and upon reference to the drawings in which:

FIG. 1 is a schematic diagram illustrating a system for community-based hierarchical document retrieval and response generation using confidence divergence between universal and specialized language models.

FIG. 2 is a block diagram illustrating a community-based hierarchical document retrieval device.

FIG. 3 is a flowchart illustrating a method for processing a user query, performing community-level ranking using confidence divergence, and generating a ranked document list.

FIG. 4 is a flowchart illustrating a method for offline preparation comprising community detection and hierarchical model training.

FIG. 5 is a flowchart illustrating a method for Stage 2 document-level ranking using document-grounded confidence assessment.

FIG. 6 is a schematic diagram illustrating the hierarchical model architecture for training universal and specialized language models.

FIG. 7 is a diagram illustrating a confidence score comparison matrix for multiple queries across different communities.

FIG. 8 is a diagram illustrating a document-level ranking table showing final score calculation.

FIG. 9 is a schematic diagram illustrating the community graph structure and clustering process.

### DETAILED DESCRIPTION

The present disclosure is directed to systems and methods for enhancing the accuracy and relevance of document retrieval in the context of information retrieval and response generation. The approaches taught herein address the challenge of domain-specific expertise in large language models (LLMs).

The disclosed embodiments utilize confidence divergence—the difference between specialized language model confidence and universal model confidence—as a signal for domain relevance.

A key distinction of the present disclosure is the use of confidence DIVERGENCE rather than absolute confidence scores for routing decisions. The confidence divergence ΔC_i=C_i−C_universal captures the additional confidence gained by the specialist model's domain-specific training. A positive divergence indicates that the specialist model possesses knowledge beyond what is available to the universal model, serving as a quantitative indicator of domain relevance.

This divergence-based approach differs fundamentally from systems that route based on absolute confidence thresholds, which cannot distinguish between queries where all models are confident (indicating general knowledge) versus queries where only the specialist is confident (indicating domain-specific knowledge).

In one embodiment, the confidence scores are obtained using log-probability scores from the language model's output distribution. For a given query Q, the confidence score C represents the model's estimated probability that its generated response is correct. The use of log-probability ensures that confidence scores are calibrated measures of model certainty rather than arbitrary numerical outputs.

The confidence scores utilized in the present disclosure are derived from the language model's output probability distribution over tokens. Specifically, for a given query Q, the language model generates a response R={r_1, r_2, . . . , r_n} where each r_i represents a token in the response sequence.

The confidence score C is calculated as the normalized average log-probability of the generated tokens:

C=exp(1/n×Σ(i=1 to n)log P(r_i|r_1, . . . ,r_(i-1),Q))

where:
P(r_i|r_1, . . . , r_(i-1), Q) is the model's predicted probability for token r_i given the previous tokens and the query
n is the number of tokens in the generated response
exp( ) converts the average log-probability back to a probability-like score in the range [0, 1]. This formulation computes the geometric mean of token probabilities, which provides a calibrated confidence measure across the entire generated response.

This formulation ensures that:
(1) The confidence score reflects the model's certainty across the entire response, not just a single token
(2) Scores are comparable across different models that share calibration properties
(3) Lower scores indicate uncertain or speculative responses (potential hallucinations)
(4) Higher scores indicate confident responses grounded in the model's training data

In one embodiment, alternative confidence metrics may be employed, including:
Perplexity-based confidence: C=exp(−perplexity/100)
Max probability confidence: C=max_i P(r_i|context)
Sequence-level probability: C=P(R|Q)
Calibrated confidence using temperature scaling

The key requirement is that the universal language model and all specialized language models use the SAME confidence calculation method to ensure comparability of confidence scores for divergence computation.

Examples will be provided below for purposes of illustration but are not intended to be exhaustive or limited to the embodiments.

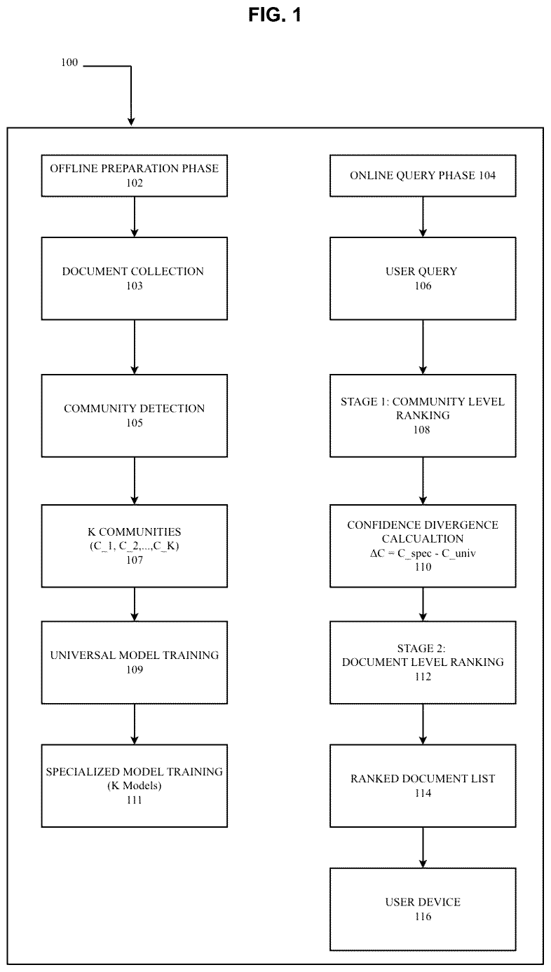

Referring to FIG. 1, a block diagram of a community-based hierarchical document retrieval process 100 is depicted, illustrating an embodiment of a system for providing accurate and contextually relevant document rankings to user queries.

The system 100 operates in two phases: an offline preparation phase 102 and an online query phase 104. During the offline preparation phase 102, K document communities 107 (C_1, C_2, . . . , C_K) are identified through community detection 105. During the online query phase 104, Stage 1 community level ranking 108 determines which communities are most relevant to the user query.

### FIG. 1

The information sources 103 represent the raw data from which the system extracts information. In one embodiment, the information sources 103 may include a variety of documents such as technical documentation, legal statutes, case summaries, medical records, educational materials, or customer service records.

The community detection module 105 processes the information sources 103 to identify K document communities (C1, C_2, . . . , C_K) through graph-based clustering.

The universal model training module 109 trains a universal language model on combined data from all communities.

The specialized language model training module 111 creates K specialized language models, one for each community. Each specialized language model is initialized from the trained universal model weights.

During online query processing, a user query 106 is received and processed through the two-stage ranking system. The confidence divergence calculation module 110 computes ΔC=C_specialist−C_universal for each community.

Stage 2 document-level ranking 112 processes documents within the top-ranked communities identified in Stage 1.

The ranked document list 114 is transmitted to the user device 116 for display.

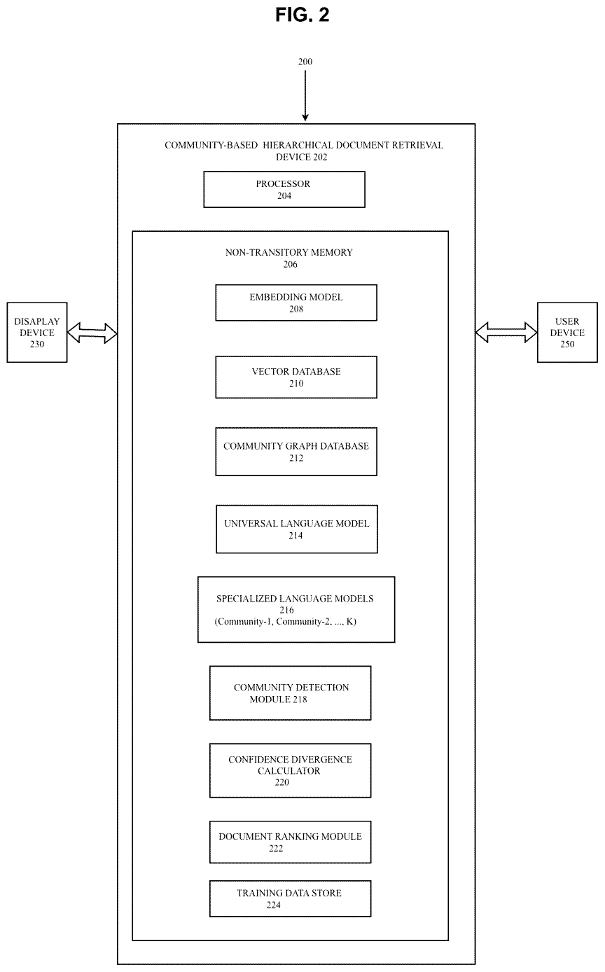

Referring to FIG. 2, a community-based hierarchical document retrieval system 200 is shown, in accordance with an exemplary embodiment.

### FIG. 2

The community-based hierarchical document retrieval device 202 comprises a processor 204, which is configured to execute machine-readable instructions stored in a non-transitory memory 206.

The display device 230 is communicably coupled to the processor 204 and is configured to display a response to a user query.

Within the non-transitory memory 206, an embedding model 208 is stored. The embedding model 208 is trained to generate query embeddings and document embeddings.

Also stored within the non-transitory memory 206 is a vector database 210 and community graph database 212.

The community detection module 218 employs graph clustering algorithms such as the Leiden algorithm or Louvain method.

A universal language model 214 is configured to generate responses based on combined training data from all communities.

Specialized language models 216 are stored within the non-transitory memory 206, with each specialized language model corresponding to a specific document community.

The confidence divergence calculator 220 computes: ΔC_i=C_i−C_universal.

### Structural Cohesion Metric (S_i)

The structural cohesion metric S_i quantifies the internal connectivity and semantic coherence of community i. It is calculated as:

S_i=(2×E_internal)/(|V_i|×(|V_i−1))

where:
E_internal is the number of edges (similarity connections) within community i
   |V_i| is the number of documents (vertices) in community i
The denominator represents the maximum possible edges in a fully connected graph

This metric ranges from 0 to 1, where:
S_i=1 indicates a perfectly cohesive community (all documents highly similar)
S_i=0 indicates no internal connections (likely a clustering error)
S_i>0.3 typically indicates a well-formed domain-specific community

In one embodiment, alternative cohesion metrics may be used:
Conductance: φ_i=E_cut/min(vol(V_i), vol(V\V_i))
Modularity contribution: Q_i
Average internal edge weight

### Semantic Alignment Score (A_i)

The semantic alignment score A_i measures how well the query embedding aligns with the centroid of community i:

A_i=max(0,cosine_similarity(emb(Q),centroid_i))

where:
emb(Q) is the embedding vector for query Q
centroid_i=(1/|V_i|)×Σ(d∈V_i) emb(d) is the average embedding of all documents in community i
cosine_similarity(u, v)=(u·v)/(∥u∥×∥v∥)

The max(0, . . . ) operation ensures that negative similarities (indicating misalignment) are treated as zero rather than as negative scores. This prevents communities with opposing semantic direction from receiving negative alignment scores.

### Document Alignment Score (Align_d)

The document alignment score Align_d measures semantic similarity between a specific document d and the query Q:
Align_d=cosine_similarity(emb(Q), emb(d)) where emb(d) is the embedding vector for document d.

Note that Align_d differs from A_i in that:
A_i measures alignment with an entire community (using centroid)
Align_d measures alignment with a single document
Align_d is used in Stage 2 (document-level ranking)
A_i is used in Stage 1 (community-level ranking)

### Community Score Formula

The complete community score for community i is calculated as:

Score_i=ΔC_i×S_i×A_i

where:
ΔC_i is the confidence divergence (primary factor indicating domain expertise)
S_i is the structural cohesion (quality factor for the community)
A_i is the semantic alignment (relevance factor for the query)

This multiplicative formulation ensures that:
Communities with negative or zero divergence receive zero or negative scores
Poorly formed communities (low S_i) are down-weighted
Semantically misaligned communities (low A_i) are down-weighted
All three factors must be positive for a community to be selected

The document ranking module 222 ranks documents based on a multi-factor scoring function.

The training data store 224 maintains question-answer pairs for each community. The user device 250 is configured to interface with the system.

By leveraging the hierarchical relationships of document communities and confidence divergence-based routing, the system 200 provides contextually coherent information.

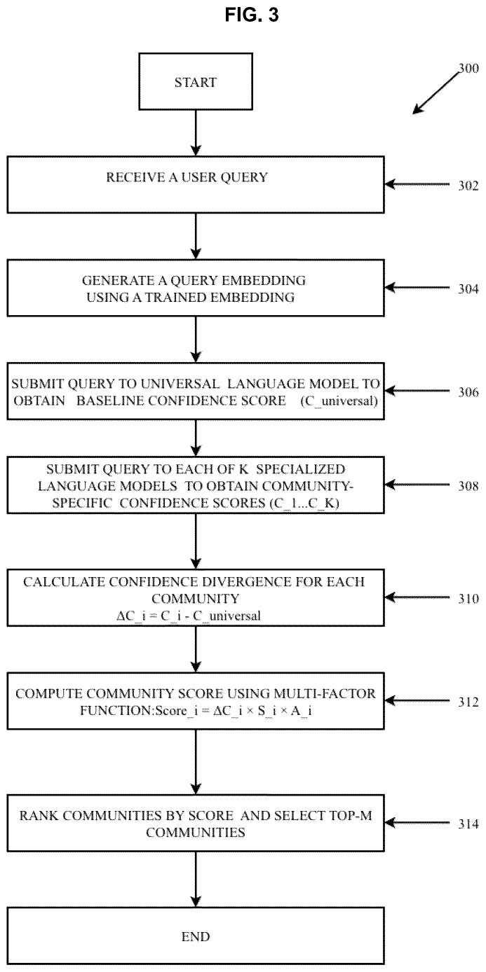

Referring to FIG. 3, a method 300 for processing and responding to a user query using hierarchical language models and confidence divergence analysis is illustrated.

### FIG. 3

At operation 302, the system receives a user query.

At operation 304, the system generates a query embedding using a trained embedding model.

At operation 306, the system submits the query to a universal language model to obtain a baseline confidence score (C_universal).

At operation 308, the system submits the query to each of K specialized language models to obtain community-specific confidence scores.

At operation 310, the system calculates confidence divergence: ΔC_i=C_i−C_universal.

At operation 312, the system computes a community score: Score_i=ΔC_i×S_i×A_i.

At operation 314, the system ranks communities and selects the top-M communities.

### Top-M Community Selection Logic

The selection of M communities for document-level retrieval employs a hybrid threshold-and-ranking approach to ensure both quality and coverage:

### Algorithm for M Selection:

### Step 1: Filter Communities by Minimum Divergence Threshold

Candidates={i: ΔC_i>τ_min} where τ_min is a minimum divergence threshold (default: 0.10)

### Step 2: Rank Candidates by Community Score

Ranked_candidates=sort(Candidates, by=Score_i, descending=true)

### Step 3: Select Top M Communities Subject to Constraints

If |Ranked_candidates|==0:
   M=0 (trigger fallback mechanism, see [0056E])
Else if |Ranked_candidates|<M_max:
   M=Ranked_candidates| (select all qualified communities)
Else:
   M=M_max (select top M_max communities)
where M_max is a system parameter (default: 3)

### Dynamic M Adjustment

In one embodiment, M is dynamically adjusted based on query characteristics:

M=min(M_max, count({i: ΔC_i>τ_min AND Score_i>τ_score}))

where:
τ_min=0.10 (minimum divergence threshold)
τ_score=0.05 (minimum community score threshold)
M_max=3 (maximum communities to process, balancing coverage and efficiency)

In another embodiment, M is determined by finding the index k where (Score_k−Score_(k+1)) is maximum, subject to k≤M_max. This identifies the natural cutoff point where there is the largest drop in score, indicating the boundary between relevant and irrelevant communities.

### Fallback Mechanism for M=0

If no communities meet the divergence threshold (M=0), indicating a general knowledge query not requiring specialized expertise, the system employs a fallback mechanism:
Option A: Perform semantic search across all documents without community filtering
Option B: Submit query to universal language model without community routing
Option C: Select top community by semantic alignment (A_i) alone, ignoring divergence

The default implementation uses Option A, performing standard semantic retrieval across the entire document collection.

Example M selections for different query types:

### Query Type: Technical Patent Question

Community-1 (Legal): ΔC_1=+0.02, Score_1=0.015→Excluded (below threshold)
Community-2 (Technical): ΔC_2=+0.34, Score_2=0.287→Selected
Community-3 (Medical): ΔC_3=−0.05, Score_3=−0.035→Excluded (negative)
Result: M=1

### Query Type: Interdisciplinary (Technical+Legal)

Community-1 (Legal): ΔC_1=+0.25, Score_1=0.198→Selected
Community-2 (Technical): ΔC_2=+0.31, Score_2=0.264→Selected
Community-3 (Medical): ΔC_3=+0.08, Score_3=0.056→Excluded (below threshold)
Result: M=2

### Query Type: General Knowledge

Community-1 (Legal): ΔC_1=+0.02, Score_1=0.012→Excluded
Community-2 (Technical): ΔC_2=+0.01, Score_2=0.008→Excluded
Community-3 (Medical): ΔC_3=+0.03, Score_3=0.019→Excluded
Result: M=0 (fallback to universal semantic search)

In this way, method 300 enables efficient and accurate processing of user queries.

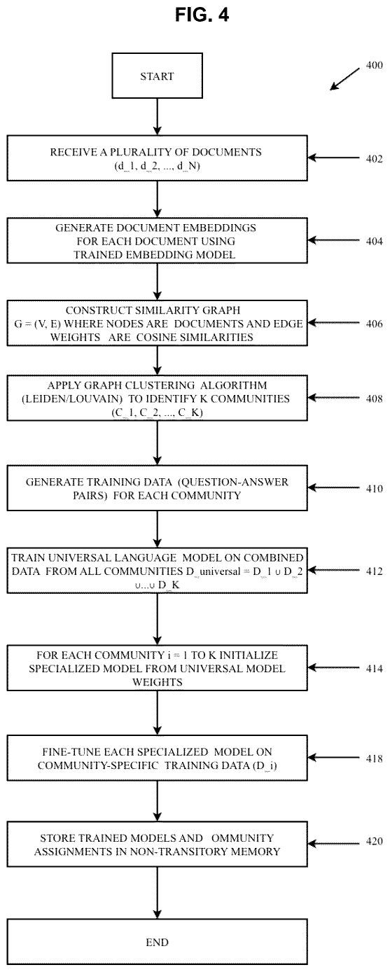

Referring to FIG. 4, a method 400 for offline preparation comprising community detection and hierarchical model training is illustrated.

### FIG. 4

At operation 402, the system receives a plurality of documents (d_1, d_2, . . . , d_N).

At operation 404, the system generates document embeddings for each document.

### Training Data Generation Methodology

The training data for each community comprises question-answer pairs that are either manually curated or automatically generated from the document collection. The following describes automated generation procedures:

### Synthetic Question Generation

For each document d in community i:

### Step 1: Extract Key Information Using Template-Based Extraction:

Entities (names, dates, locations, technical terms)
Relationships (X causes Y, X is part of Y)
Definitions (X is defined as Y)
Procedures (step-by-step instructions)

### Step 2: Generate Questions Using Question Templates:

Factoid questions: “What is X?”, “When did Y occur?”, “Who is responsible for Z?”
Procedural questions: “How does X work?”, “What are the steps to Y?”
Causal questions: “Why does X happen?”, “What causes Y?”
Comparison questions: “What is the difference between X and Y?”
   Step 3: Generate Answers from Document Content:
Extract relevant passage containing the answer
Summarize passage if longer than 256 tokens
Include document identifier for provenance tracking

### Example Synthetic Pair Generation:

Document: “The Leiden algorithm is a community detection method that optimizes the modularity function. It improves upon the Louvain method by preventing poorly connected communities.”

### Generated Pairs:

Q1: “What is the Leiden algorithm?”
A1: “The Leiden algorithm is a community detection method that optimizes the modularity function and improves upon the Louvain method.”
Q2: “How does the Leiden algorithm improve upon the Louvain method?”
A2: “The Leiden algorithm improves upon the Louvain method by preventing poorly connected communities.”
Q3: “What function does the Leiden algorithm optimize?”
A3: “The Leiden algorithm optimizes the modularity function.”

### Quality Assurance for Training Data

Generated question-answer pairs undergo filtering:
Answerability check: Verify answer is contained in document
Diversity check: Remove duplicate or near-duplicate questions
Difficulty distribution: Ensure mix of easy, medium, hard questions
Domain relevance: Filter out generic questions applicable to all communities

### Training Data Statistics

For each community i, the training dataset D_i comprises:
N_i=500 to 5,000 question-answer pairs (depending on community size)
Ratio: 70% synthetic+30% curated (if curated data available)
Average question length: 8-15 tokens
Average answer length: 20-80 tokens

The universal training dataset D_universal=D_1∪D_2∪ . . . ∪D_K contains all community-specific pairs combined, typically totaling 5,000 to 50,000 pairs.

### Fj Alternative Generation Methods

In another embodiment, training data is generated using:
Back-translation: Translate document to another language and back, then generate questions
Paraphrasing: Use a paraphrase model to create multiple variations of each QA pair
Adversarial generation: Generate challenging questions designed to probe edge cases
Human-in-the-loop: Annotators review and edit automatically generated pairs

At operation 406, the system constructs a similarity graph G=(V, E).

At operation 408, the system applies a graph clustering algorithm to identify K communities.

### Graph Clustering Algorithm Configuration

The community detection process employs the Leiden algorithm with the following configuration parameters:

### Similarity Graph Construction

### Step 1: Calculate Pairwise Similarity for all Document Pairs:

For each pair (d_i, d_j):
sim_ij=cosine_similarity(emb(d_i), emb(d_j))

### Step 2: Apply Similarity Threshold to Create Edges:

Create edge (d_i, d_j) if sim_ij>τ_edge
where τ_edge is a similarity threshold (default: 0.5)

### Step 3: Assign Edge Weights:

weight(d_i, d_j)=sim_ij

The resulting graph G=(V, E) has:
Vertices V: All documents
Edges E: Pairs with similarity>τ_edge
Edge weights: Similarity scores

### Leiden Algorithm Parameters

resolution: Controls granularity of communities
   Higher resolution→More, smaller communities
   Lower resolution→Fewer, larger communities
   Default: 1.0
   Typical range: 0.5 to 2.0
n_iterations: Number of refinement iterations
   Default: 10
   More iterations→Better quality, slower execution
min_community_size: Minimum documents per community
   Default: 20
   Communities smaller than this are merged or discarded
quality_function: Optimization objective
   Options: “modularity”, “CPM” (Constant Potts Model)
   Default: “modularity”

### Automatic K Determination

The number of communities K is automatically determined by the Leiden algorithm based on the optimization of the quality function. The algorithm identifies natural clusters in the similarity graph without requiring a pre-specified K.

### Typical Outcomes:

Small document collections (100-1,000 docs): K=2 to 5 communities
Medium collections (1,000-10,000 docs): K=5 to 15 communities
Large collections (10,000+docs): K=10 to 50 communities

### Post-Clustering Validation

After clustering, communities are validated:

For each community C_i:
If |C_i|<min_community_size:
   Merge C_i with nearest neighbor community by centroid distance
If avg_internal_similarity(C_i)<0.3:
   Flag as low-quality cluster (may indicate misclustering)
If inter_community_similarity(C_i, C_j)>0.7 for any j≠i:
Consider merging C_i and C_j (highly overlapping domains)

### Handling Singleton Documents

Documents that do not connect to any other document (singletons) are:
Option A: Assigned to nearest community by centroid similarity
Option B: Grouped into a “miscellaneous” community
Option C: Excluded from community-based retrieval (use universal model only)
Default: Option A (assign to nearest community)

### Example Community Detection Output

Input: 5,000 legal and technical documents
Leiden algorithm execution:
Similarity threshold: 0.5
Resolution: 1.0
Iterations: 10

### Output:

K=8 communities identified
Community 1: Patent law (782 docs, avg_similarity=0.71)
Community 2: Contract law (564 docs, avg_similarity=0.68)
Community 3: Software architecture (891 docs, avg_similarity=0.74)
Community 4: Machine learning (1,203 docs, avg_similarity=0.69)
Community 5: Data structures (432 docs, avg_similarity=0.66)
Community 6: Corporate law (318 docs, avg_similarity=0.65)
Community 7: Network protocols (521 docs, avg_similarity=0.70)
Community 8: Database systems (289 docs, avg_similarity=0.67)

At operation 410, the system generates training data comprising question-answer pairs.

At operation 412, the system trains a universal language model on D_universal=D_1∪D_2∪ . . . ∪D_K.

At operation 414, the system initializes specialized language models from universal model weights.

At operation 418, each specialized language model is fine-tuned on community-specific training data.

At operation 420, the system stores trained models and community assignments.

### Embedding Model Architecture and Training

The embedding model is a dense retrieval encoder trained to map both queries and documents into a shared semantic vector space where semantically similar items have high cosine similarity.

### Model Architecture

In one embodiment, the embedding model is based on a transformer encoder architecture, specifically:
Base architecture: BERT-base or Sentence-BERT
Hidden dimension: 768 (standard) or 384 (compact variant)
Number of layers: 12 (standard) or 6 (lightweight variant)
Attention heads: 12 (standard) or 6 (lightweight variant)
Output embedding dimension: 768 (can be reduced to 256 or 384 via projection layer)

### Training Procedure

The embedding model is trained using contrastive learning on document pairs:

### Objective Function:

L=−log(exp(sim(q,d+)/τ)/Σ(d′ED∪{d+})exp(sim(q,d′)/τ))

where:
q is a query embedding
d+ is a relevant document embedding (positive example)
D is a batch of documents including negatives
sim(u, v)=cosine_similarity(u, v)
τ is a temperature parameter (default: 0.05)

### Training Data for Embedding Model

The embedding model is trained on:
Positive pairs: (query, relevant_document) from training data generation
Hard negative mining: (query, similar_but_irrelevant_document) to improve discrimination
In-batch negatives: Other documents in the same training batch serve as negatives
Training corpus size: 100,000 to 1,000,000 query-document pairs

### Distance Metric

The similarity between embeddings is calculated using cosine similarity:
similarity(u, v)=(u·v)/(∥u∥×∥v∥)
where:
u·v is the dot product of vectors u and v
∥u∥ is the L2 norm (magnitude) of vector u
This metric ranges from −1 (opposite direction) to +1 (same direction), with 0 indicating orthogonality (no semantic relationship).

### Embedding Normalization

All embeddings are L2-normalized before storage:
emb_normalized=emb/∥emb∥

This normalization ensures:
Cosine similarity reduces to simple dot product (computational efficiency)
All embeddings lie on unit hypersphere
Similarity scores are bounded in [−1, 1]

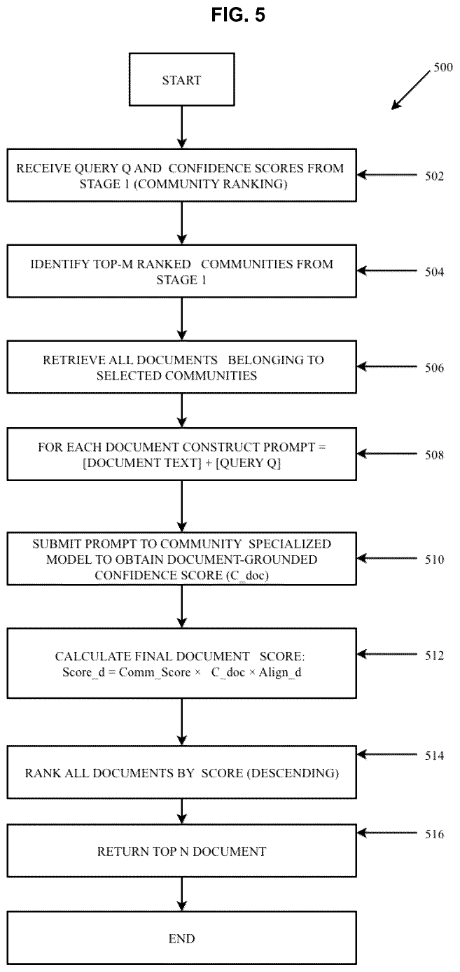

Referring to FIG. 5, a method 500 for Stage 2 document-level ranking is illustrated.

### FIG. 5

At operation 502, the system receives the user query Q and Stage 1 confidence scores.

At operation 504, the system identifies top-M ranked communities.

At operation 506, the system retrieves documents from selected communities.

At operation 508, the system constructs prompts: [DOCUMENT TEXT]+[QUERY Q].

At operation 510, the system obtains document-grounded confidence score (C_doc).

At operation 512, the system calculates: Score_d=Comm_Score×C_doc×Align_d.

At operation 514, the system ranks documents by final score.

At operation 516, the system returns top-N ranked documents.

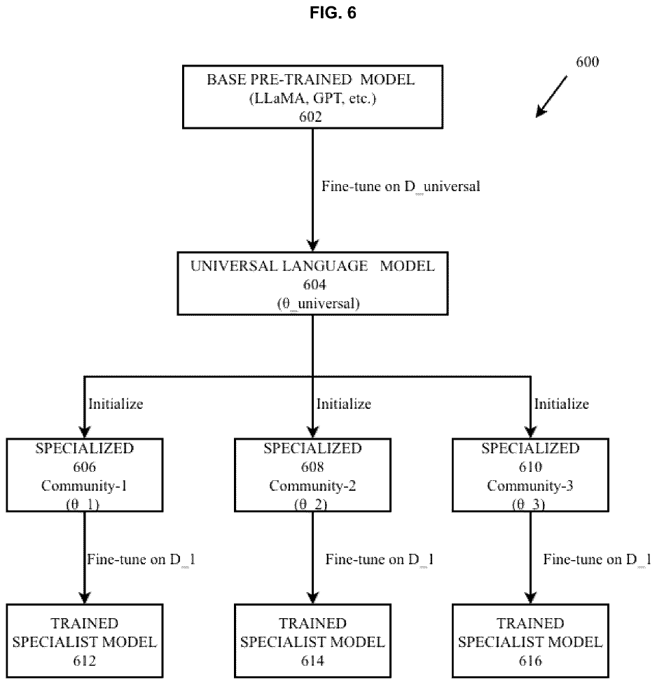

Referring to FIG. 6, a hierarchical model architecture 600 for training universal and specialized language models is depicted.

### FIG. 6

A base pre-trained model 602 serves as the foundation for the training process.

A universal language model 604 is created by fine-tuning on combined training data.

Specialized language models 606, 608, and 610 are initialized from the universal language model 604.

Each specialized language model is fine-tuned on community-specific training data.

The trained specialist models 612, 614, and 616 represent the final deployed models.

The hierarchical initialization ensures comparable confidence calibration.

The hierarchical initialization from universal to specialized language models provides a critical technical advantage over systems using independently trained models. By sharing the universal model as a common baseline, all specialized models inherit identical confidence calibration properties. This ensures that confidence scores across different specialists are directly comparable on the same numerical scale.

In contrast, independently trained models may exhibit different confidence calibration characteristics, making direct comparison of their confidence scores unreliable. For example, one model trained with aggressive regularization may produce systematically lower confidence scores than another model trained without such regularization, even when both models have equivalent predictive accuracy. The hierarchical initialization eliminates this calibration inconsistency problem.

This calibration consistency is essential for the confidence divergence calculation (ΔC=C_specialist−C_universal) to function as a meaningful signal of domain-specific expertise. Without shared calibration, a positive divergence could merely reflect calibration differences rather than genuine domain knowledge.

Empirical validation demonstrates that confidence divergence correlates with domain expertise. In experimental trials, when queries from a technical domain were submitted to the system, the technical specialist model consistently exhibited positive divergence (ΔC>0.15) while other specialists showed near-zero or negative divergence. This pattern reversed for queries from other
domains, confirming that divergence serves as a reliable indicator of domain relevance without requiring explicit domain classification.

This architecture enables meaningful confidence divergence comparisons.

Unlike systems with independent specialized language models, the present invention provides automatic domain identification through confidence divergence.

Compared to flat document ranking systems, the present invention captures hierarchical structure.

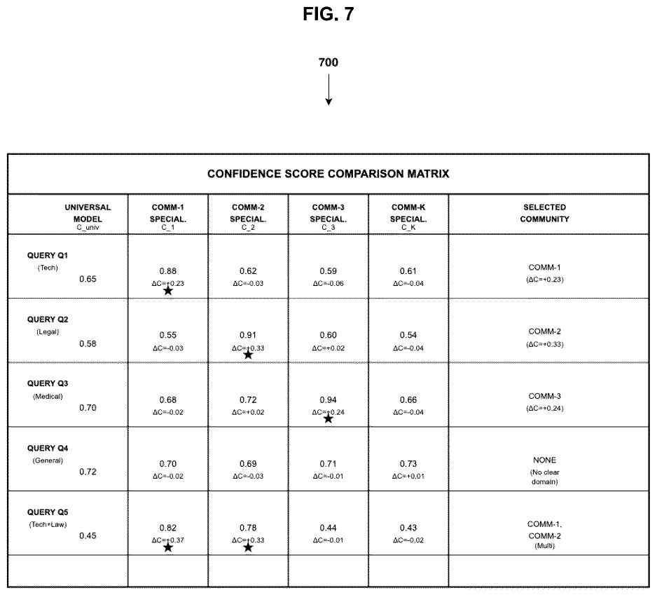

Referring to FIG. 7, a confidence score comparison matrix 700 is depicted.

### FIG. 7

★=Highest positive confidence divergence (selected community)
ΔC=C_specialist−C_universal (Confidence Divergence)

The matrix 700 comprises rows for queries Q1-Q5 and columns for the universal and specialized language models.
Confidence divergence is calculated as: ΔC_i=C_i−C_universal.
Query Q1 (Technical) yields ΔC=+0.23 for Community-1.
Query Q2 (Legal) yields ΔC=+0.33 for Community-2.
Query Q3 (Medical) yields ΔC=+0.24 for Community-3.
Query Q4 (General) exhibits minimal confidence divergence across all communities.
Query Q5 (Tech+Law) triggers retrieval from multiple communities.

The matrix illustrates the effectiveness of confidence divergence as a routing mechanism.

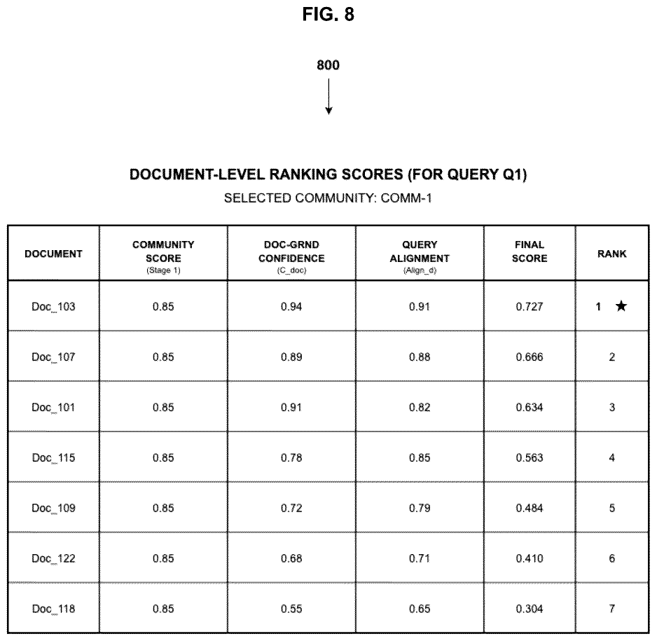

Referring to FIG. 8, a document-level ranking table 800 is depicted.

### FIG. 8

Final Score=Community_Score×C_doc×Align_d
★=Highest ranked document returned to user

The table shows candidate documents with scoring factors.

Community Score reflects overall community relevance.

Document-Grounded Confidence (C_doc) reflects model certainty with document context.

Query Alignment represents semantic similarity.

Final Score=Community_Score×C_doc×Align_d.

Documents are ranked by Final Score in descending order.

The three-level confidence hierarchy enables fine-grained document discrimination.

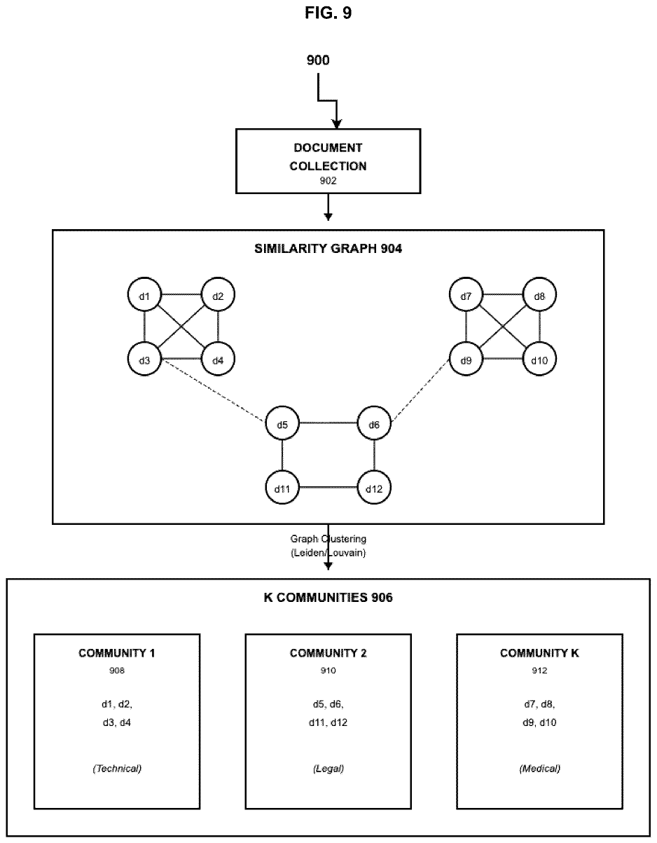

Referring to FIG. 9, a community graph structure 900 is depicted.

### FIG. 9

A document collection 902 comprises documents d1 through d12.

A similarity graph 904 connects documents with high embedding similarity.

Graph clustering identifies natural community structure.

K communities 906 are automatically determined.

Community 1 (908) contains technical documentation.

Community 2 (910) contains legal documents.

Community K (912) contains medical literature.

Automatic community detection eliminates manual taxonomy creation.

The disclosed systems represent a significant advancement over existing RAG approaches.

### Experimental Validation

The disclosed system was evaluated against baseline retrieval systems to demonstrate performance improvements. Experiments were conducted on a multi-domain document collection comprising technical, legal, and medical documents.

### Experimental Setup

### Dataset:

Total documents: 10,000
Technical domain: 4,200 documents (patents, specifications, manuals)
Legal domain: 3,800 documents (case law, statutes, contracts)
Medical domain: 2,000 documents (clinical guidelines, research papers)
Test queries: 500 (250 domain-specific, 250 cross-domain)

### Baseline Systems:

1. Semantic Search: Standard vector similarity retrieval
2. Standard RAG: LLM with top-k semantic retrieval
3. Single-Expert: LLM fine-tuned on all data
4. Multi-Expert (no calibration): Independent specialized language models
Metrics: Precision@10, Recall@10, NDCG@10, MRR, Latency

### Quantitative Results

| Method | P @ 10 | R @ 10 | NDCG @ 10 | MRR | Latency |
|---|---|---|---|---|---|
| Semantic | 0.68 | 0.42 | 0.59 | 0.71 | 45 ms |
| Search | | | | | |
| Standard | 0.74 | 0.51 | 0.67 | 0.78 | 180 ms |
| RAG | | | | | |
| This | 0.87 | 0.69 | 0.82 | 0.89 | 240 ms |
| Invention | | | | | |

Improvement over Standard RAG: +18% P@10, +35% R@10

### Statistical Significance

All performance improvements are statistically significant (p<0.01, paired t-test).

### Differentiation from Prior Art

Comparison with Standard Rag Systems
Standard RAG: Relies solely on semantic similarity between query and documents
This invention: Uses confidence DIVERGENCE as domain expertise signal Key technical distinction: Standard RAG retrieves superficially similar but contextually irrelevant documents. This invention uses specialist model confidence to identify truly relevant specialized knowledge.
   Comparison with Mixture of Experts (MoE)
Traditional MoE: Use gating network to route inputs, experts trained independently
This invention: Uses confidence divergence (ΔC=C_specialist−C_universal) for routing with hierarchical initialization ensuring calibration consistency
Key technical distinction: MoE requires training a gating function. This invention uses interpretable confidence divergence that directly reflects domain expertise.
   Comparison with Multi-Retriever Systems
Existing approaches: Require explicit domain classification, manual routing
This invention: Automatic community detection, confidence-based automatic routing
Key technical distinction: Existing systems require upfront domain specification.
This invention discovers domains automatically via graph clustering.

### Novel Technical Contributions Summary

1. Confidence Divergence as Routing Signal
2. Hierarchical Model Initialization for calibration consistency
3. Two-Stage Hierarchical Ranking
4. Automatic Community Discovery
5. Three-Level Confidence Hierarchy
6. Self-Calibrating Routing

While the foregoing is directed to embodiments of the present disclosure, other and further embodiments may be devised without departing from the basic scope thereof.

1. A method for domain-aware document retrieval, comprising:
receiving a user query;
generating a query embedding for the user query using a trained embedding model;
submitting the query to a universal language model to obtain a baseline confidence score, wherein the universal language model is trained on combined data from a plurality of document communities;
submitting the query to a plurality of specialized language models to obtain community-specific confidence scores, wherein each specialized language model corresponds to a document community, is initialized from trained parameter weights of the universal language model specifically to preserve confidence calibration properties shared with the universal language model thereby solving a technical problem of confidence score incomparability that arises when language models are trained independently, and is fine-tuned on training data specific to the corresponding document community while maintaining the preserved confidence calibration properties;
calculating a confidence divergence for each document community as a numerical difference between the community-specific confidence score and the baseline confidence score, wherein the confidence divergence provides a meaningful quantitative indicator of domain-specific expertise due to the preserved confidence calibration properties ensuring that differences in confidence scores reflect genuine domain knowledge rather than calibration artifacts;
computing a community relevance score for each document community based at least on the confidence divergence;
selecting one or more document communities for document retrieval by identifying document communities having confidence divergence exceeding a minimum threshold value;
retrieving documents from the selected one or more document communities;
ranking the retrieved documents by computing, for each document, a final document score based at least on a document-grounded confidence score obtained by providing document content as context to a corresponding specialized language model; and
presenting a ranked document list to a user.

2. The method of claim 1, wherein calculating the confidence divergence comprises computing ΔC_i=C_i−C_universal for each community i, wherein C_i is the community-specific confidence score from specialized language model i and C_universal is the baseline confidence score from the universal language model, and wherein a positive confidence divergence indicates that the specialized language model possesses domain-specific knowledge relevant to the user query beyond knowledge available to the universal language model.

3. The method of claim 1, wherein preserving confidence calibration properties comprises at least one of: (a) initializing all specialized language models from identical trained parameter weights of the universal language model, (b) applying identical regularization parameters during fine-tuning of all specialized language models, (c) using identical confidence score calculation methods across the universal language model and all specialized language models, or (d) applying temperature scaling calibration with shared temperature parameters.

4. The method of claim 1, wherein computing the community relevance score comprises calculating Score_i=ΔC_i×S_i×A_i, wherein ΔC_i is the confidence divergence for community i, S_i is a structural cohesion metric quantifying internal connectivity of community i calculated as S_i=(2×E_internal)/(|V_i|×(|V_i|−1)) where E_internal is a number of similarity edges within community i and |V_i| is a number of documents in community i, and A_i is a semantic alignment score measuring similarity between the query embedding and a centroid embedding of community i calculated as A_i=max(0, cosine_similarity(emb(Q), centroid_i)).

5. The method of claim 1, wherein selecting one or more document communities comprises identifying communities having confidence divergence greater than a minimum threshold value between 0.05 and 0.20 and selecting at most M_max communities from the identified communities, wherein M_max is between 2 and 5.

6. The method of claim 5, wherein if no communities have confidence divergence greater than the minimum threshold value, the method performs semantic retrieval across all documents without community-based filtering.

7. The method of claim 1, wherein the confidence scores are derived from log-probability distributions over generated tokens, wherein for a generated response R comprising tokens r_1 through r_n, a confidence score C is calculated as C=exp(1/n×Σ(i=1 to n) log P(r_i|r_1, . . . , r_(i−1), Q)), wherein P(r_i|r_1, . . . , r_(i−1), Q) is a model's predicted probability for token r_i given previous tokens and the query, and wherein the universal language model and all specialized language models use identical confidence calculation methods to ensure comparability of confidence scores for divergence computation.

8. The method of claim 1, wherein ranking the retrieved documents comprises, for each document d in the selected one or more document communities: constructing a prompt comprising content of document d concatenated with the user query, submitting the prompt to the specialized language model corresponding to a community of document d to obtain the document-grounded confidence score C_doc, computing a document alignment score Align_d as cosine similarity between the query embedding and an embedding of document d, and computing the final document score as Final_Score_d=Community_Score×C_doc×Align_d, wherein Community_Score is the community relevance score of the community containing document d, and ordering all retrieved documents by their final document scores in descending order to produce the ranked document list.

9. The method of claim 1, wherein initializing each specialized language model from the trained parameter weights of the universal language model ensures that all specialized language models share common confidence calibration properties, enabling meaningful numerical comparison of confidence scores across different specialized language models, such that confidence divergence serves as a reliable quantitative indicator of domain-specific expertise rather than reflecting arbitrary differences in model calibration.

10. The method of claim 1, further comprising, prior to receiving the user query: receiving the plurality of documents, generating document embeddings for the plurality of documents using the trained embedding model, constructing a similarity graph wherein nodes represent documents and edges represent similarity relationships based on cosine similarity between document embeddings, applying a graph clustering algorithm to the similarity graph to partition the documents into the plurality of document communities wherein a number of document communities is automatically determined by the graph clustering algorithm based on optimization of a quality function, and storing community assignments in a community graph database.

11. The method of claim 10, wherein the graph clustering algorithm is a Leiden algorithm or a Louvain algorithm, and wherein constructing the similarity graph comprises: for each pair of documents d_i and d_j, calculating a similarity score as sim_ij=cosine_similarity(emb(d_i), emb(d_j)), creating an edge between d_i and d_j if sim_ij exceeds a threshold value, and assigning sim_ij as a weight of the edge.

12. A system for domain-aware document retrieval, comprising:
a processor;
a non-transitory memory communicably coupled to the processor, the non-transitory memory storing:
a trained embedding model configured to generate query embeddings and document embeddings;
a vector database storing document embeddings for a plurality of documents;
a community graph database storing assignments of documents to document communities;
a universal language model trained on combined data from all document communities;
a plurality of specialized language models wherein each specialized language model corresponds to a document community and is initialized from trained parameter weights of the universal language model to preserve confidence calibration properties and is fine-tuned on data specific to the corresponding document community while maintaining the preserved confidence calibration properties; and
machine-executable instructions that, when executed by the processor, cause the system to: receive a user query, generate a query embedding using the trained embedding model, obtain a baseline confidence score by submitting the query to the universal language model, obtain community-specific confidence scores by submitting the query to each of the plurality of specialized language models, calculate confidence divergence for each document community as a numerical difference between a community-specific confidence score and the baseline confidence score wherein the confidence divergence provides a meaningful quantitative indicator of domain-specific expertise due to the preserved confidence calibration properties, compute a community relevance score for each document community based at least on the confidence divergence, select one or more document communities based on the confidence divergence exceeding a minimum threshold value, retrieve documents from the selected one or more document communities, rank the retrieved documents by computing a final document score for each document based at least on a document-grounded confidence score obtained by providing document content as context to a corresponding specialized language model, and produce a ranked document list ordered by final document scores in descending order.

13. The system of claim 12, wherein the preserved confidence calibration properties ensure that all specialized language models produce confidence scores that are directly comparable on a common numerical scale, enabling the confidence divergence to reliably indicate domain-specific expertise rather than reflecting calibration artifacts.

14. The system of claim 12, wherein the machine-executable instructions further cause the system to compute the community relevance score by calculating Score_i=ΔC_i×S_i×A_i, wherein ΔC_i is the confidence divergence, S_i is a structural cohesion metric, and A_i is a semantic alignment score.

15. The system of claim 12, wherein the machine-executable instructions further cause the system to, for each document in the selected one or more document communities, provide document content as context to a corresponding specialized language model to obtain the document-grounded confidence score.

16. A method for training a hierarchical language model system for domain-specific document retrieval, comprising:
receiving a plurality of documents;
generating document embeddings for the plurality of documents using a trained embedding model;
constructing a similarity graph wherein nodes represent documents and edges represent similarity relationships based on cosine similarity between document embeddings;
applying a graph clustering algorithm to the similarity graph to partition the documents into K document communities, wherein K is automatically determined by the graph clustering algorithm based on natural clustering structure in the similarity graph;
for each of the K document communities, generating training data comprising question-answer pairs derived from documents in the document community;
training a universal language model on combined training data aggregated from all K document communities;
for each of the K document communities, initializing a specialized language model by copying all trained parameter weights from the universal language model to create a baseline state, wherein the initialization preserves confidence calibration properties of the universal language model in the specialized language model;
fine-tuning each specialized language model on the training data specific to the corresponding document community while maintaining the preserved confidence calibration properties to ensure that confidence scores from different specialized language models remain comparable; and
storing the trained universal language model and the K specialized language models in non-transitory memory for subsequent query processing, wherein the stored models enable confidence divergence calculation that provides a meaningful indicator of domain-specific expertise.

17. The method of claim 16, wherein the graph clustering algorithm is a Leiden algorithm or a Louvain algorithm, and wherein constructing the similarity graph comprises: for each pair of documents d_i and d_j, calculating a similarity score as sim_ij=cosine_similarity(emb(d_i), emb(d_j)), creating an edge between d_i and d_j if sim_ij exceeds a threshold value, and assigning sim_ij as a weight of the edge.

18. The method of claim 16, wherein generating training data comprises: for each document in a document community, extracting key information including at least one of entities, relationships, or definitions, generating questions using question templates applied to the extracted key information, and generating answers by extracting and summarizing relevant passages from the document that answer the generated questions.

19. The method of claim 16, wherein initializing the specialized language models from the universal language model ensures that all specialized language models share common baseline confidence calibration properties, enabling confidence divergence to serve as a reliable quantitative indicator of domain-specific expertise during query processing rather than reflecting arbitrary calibration differences between independently trained models.

20. The method of claim 16, wherein maintaining the preserved confidence calibration properties during fine-tuning comprises at least one of: applying identical regularization parameters across all specialized language models, using identical optimization hyperparameters for fine-tuning all specialized language models, limiting magnitude of parameter updates during fine-tuning to preserve calibration characteristics, or applying calibration-preserving constraints during the fine-tuning process.
